(19) United States
(12) Patent Application Publication
(10) Pub. No.: US 2023/0276455 A1
(43) Pub. Date: Aug. 31, 2023

(54) RESTRICTIONS BASED ON A CONFIGURED NUMEROLOGY

(71) Applicant: Lenovo (Singapore) Pte. Ltd., New Tech Park (SG)

(72) Inventors: Ankit Bhamri, Rödermark (DE); Hyejung Jung, Northbrook, IL (US); Alexander Johann Maria Golitschek Edler von Elbwart, Darmstadt (DE); Karthikeyan Ganesan, Kronberg im Taunus (DE); Ali Ramadan Ali, Kraiburg am Inn (DE)

(21) Appl. No.: 18/013,722

(22) PCT Filed: Jun. 28, 2021
(86) PCT No.: PCT/IB2021/055767

§ 371 Date: Dec. 29, 2022

Related U.S. Application Data
(60) Provisional application No. 63/045,727, filed on Jun. 29, 2020.

(51) Int. Cl. H04W 72/232; H04W 72/0446; H04L 27/26

(52) U.S. Cl. CPC H04W 72/232; H04W 72/0446; H04L 27/26025

(57) ABSTRACT

Apparatuses, methods, and systems are disclosed for restrictions based on a configured numerology. One method (700) includes receiving (702) information from a network indicating a numerology for transmission, reception, or a combination thereof. The method (700) includes determining (704) a physical downlink control channel monitoring restriction, a downlink control information format configuration restriction, a search space configuration restriction, or some combination thereof based on the numerology.

### CROSS-REFERENCE TO RELATED APPLICATIONS

This application claims priority to U.S. Patent Application Ser. No. 63/045,727 entitled “APPARATUSES, METHODS, AND SYSTEMS FOR PDCCH MONITORING AND SEARCH SPACE CONFIGURATION FOR A NEW DCI FORMAT FOR HIGH SUBCARRIER SPACING” and filed on Jun. 29, 2020 for Ankit Bhamri, which is incorporated herein by reference in its entirety.

### FIELD

The subject matter disclosed herein relates generally to wireless communications and more particularly relates to restrictions based on a configured numerology.

### BACKGROUND

In certain wireless communications networks, a device may monitor various channels. In such networks, the device may use more power than necessary to monitor the channels.

### BRIEF SUMMARY

Methods for PDCCH restrictions based on a configured numerology are disclosed. Apparatuses and systems also perform the functions of the methods. One embodiment of a method includes receiving information from a network indicating a numerology for transmission, reception, or a combination thereof. In some embodiments, the method includes determining a physical downlink control channel monitoring restriction, a downlink control information format configuration restriction, a search space configuration restriction, or some combination thereof based on the numerology.

One apparatus for restrictions based on a configured numerology includes a receiver that receives information from a network indicating a numerology for transmission, reception, or a combination thereof. In some embodiments, the apparatus includes a processor that determines a physical downlink control channel monitoring restriction, a downlink control information format configuration restriction, a search space configuration restriction, or some combination thereof based on the numerology.

Another embodiment of a method for restrictions based on a configured numerology includes determining, at a user equipment, that a sidelink transmission buffer is empty for a destination. In some embodiments, the method includes transmitting information from a network indicating a numerology for transmission, reception, or a combination thereof. A physical downlink control channel monitoring restriction, a downlink control information format configuration restriction, a search space configuration restriction, or some combination thereof is determined based on the numerology.

Another apparatus for restrictions based on a configured numerology includes a transmitter that transmits information from a network indicating a numerology for transmission, reception, or a combination thereof. A physical downlink control channel monitoring restriction, a downlink control information format configuration restriction, a search space configuration restriction, or some combination thereof is determined based on the numerology.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for restrictions based on a configured numerology;

FIG. 2 is a schematic block diagram illustrating one embodiment of an apparatus that may be used for restrictions based on a configured numerology;

FIG. 3 is a schematic block diagram illustrating one embodiment of an apparatus that may be used for restrictions based on a configured numerology;

FIG. 4 is a graph diagram illustrating one embodiment of a maximum number of monitored PDCCH candidates per slot and per serving cell;

FIG. 5 is a program code diagram illustrating one embodiment of NR candidate sequences;

FIG. 6 is a program code diagram illustrating one embodiment of UE specific sequences;

FIG. 7 is a flow chart diagram illustrating one embodiment of a method for restrictions based on a configured numerology; and

FIG. 8 is a flow chart diagram illustrating another embodiment of a method for restrictions based on a configured numerology.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

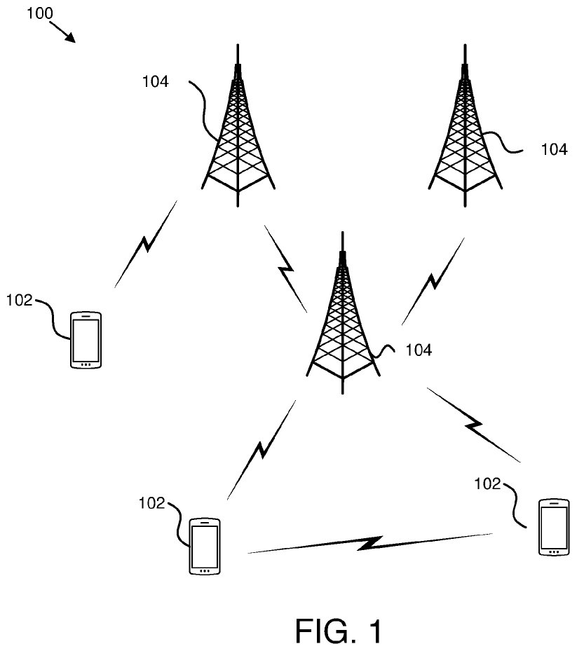

FIG. 1 depicts an embodiment of a wireless communication system 100 for restrictions based on a configured numerology. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In certain embodiments, a remote unit 102 may receive information from a network indicating a numerology for transmission, reception, or a combination thereof. In some embodiments, the remote unit 102 may determine a physical downlink control channel monitoring restriction, a downlink control information format configuration restriction, a search space configuration restriction, or some combination thereof based on the numerology. Accordingly, the remote unit 102 may be used for restrictions based on a configured numerology.

In various embodiments, a network unit 104 may transmit information from a network indicating a numerology for transmission, reception, or a combination thereof. A physical downlink control channel monitoring restriction, a downlink control information format configuration restriction, a search space configuration restriction, or some combination thereof is determined based on the numerology. Accordingly, the network unit 104 may be used for restrictions based on a configured numerology.

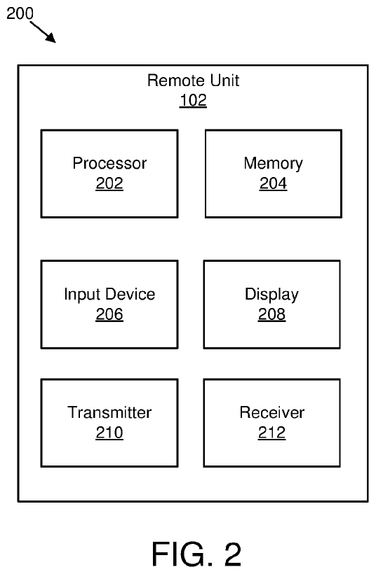

FIG. 2 depicts one embodiment of an apparatus 200 that may be used for restrictions based on a configured numerology. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

The receiver 212 may receive information from a network indicating a numerology for transmission, reception, or a combination thereof. In various embodiments, the processor 202 may determine a physical downlink control channel monitoring restriction, a downlink control information format configuration restriction, a search space configuration restriction, or some combination thereof based on the numerology.

In certain embodiments, the receiver 212 may receive information from a network indicating a numerology for transmission, reception, or a combination thereof. In various embodiments, the processor 202 may determine a physical downlink control channel monitoring restriction, a downlink control information format configuration restriction, a search space configuration restriction, or some combination thereof based on the numerology.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

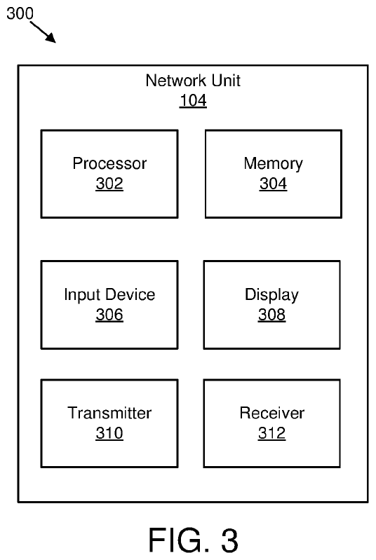

FIG. 3 depicts one embodiment of an apparatus 300 that may be used for restrictions based on a configured numerology. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In some embodiments, the transmitter 310 may transmit information from a network indicating a numerology for transmission, reception, or a combination thereof. A physical downlink control channel monitoring restriction, a downlink control information format configuration restriction, a search space configuration restriction, or some combination thereof is determined based on the numerology.

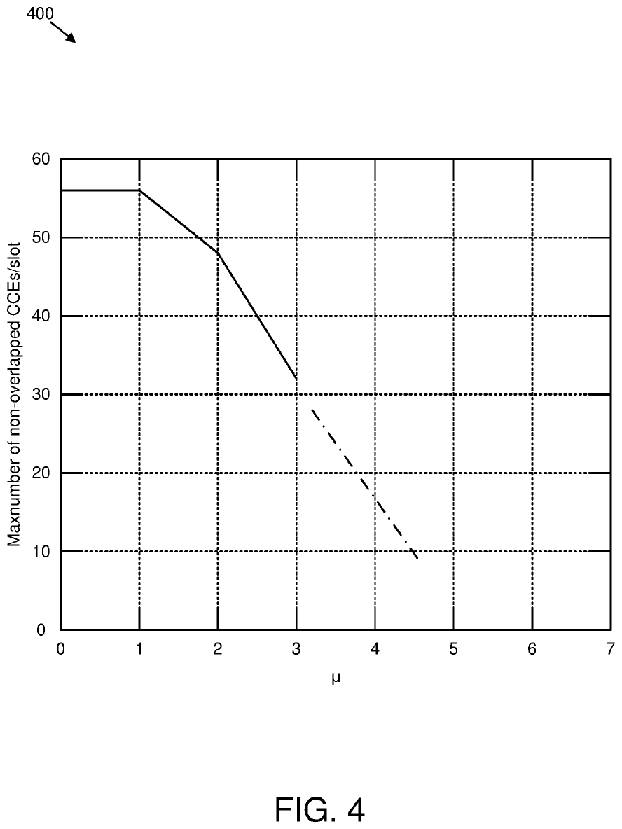

In certain embodiments, physical downlink control channel (“PDCCH”) monitoring and/or timeline may be determined if higher subcarrier spacing values (e.g., such as 480 kHz, 960 kHz, and beyond) are used for beyond 52.6 GHz. In such embodiments, if high subcarrier spacing (“SCS”) is used, PDCCH monitoring may be frequent due to shorter slot length duration. FIG. 4 illustrates that a PDCCH monitoring capability reduces significantly with increased subcarrier spacing. For beyond 52.6 GHz, with SCS values such as 480, 960 kHz, monitoring capability will likely further be reduced. In some embodiments, a need of having frequent PDCCH monitoring for a user equipment (“UE”) may be alleviated.

In various embodiments, a gNB may configure a UE to monitor a similar number of PDCCH candidates and/or non-overlapped control channel elements (“CCEs”) per given absolute time duration for different subcarrier spacings to maintain similar PDCCH blind decoding complexity for the different subcarrier spacings. For example, the UE may be configured to monitor 20 PDCCH candidates per serving cell and per 0.125 ms duration both for 120 kHz SCS and for 240 kHz SCS. In such embodiments, the number of PDCCH candidates to be monitored per slot for higher SCS (e.g., 240 kHz) becomes limited, which may result in PDCCH blocking. Alternatively, the UE may be configured to monitor a maximum number of PDCCH candidates per serving cell for multiple slots, where the number of multiple slots for which the maximum number of PDCCH candidates are configured is depending up on the configured numerology. For example, the UE capability in terms of maximum number of PDCCH candidates and/or PDCCH blind decodes is defined for 8 slots, when numerology of 960 kHz is configured or 4 slots, when numerology of 480 kHz is configured. The exact location of PDCCH candidates can be either contained in some fixed slot(s) or spread across multiple slots, symbols or some combination, thereof.

In certain embodiments, a downlink control information (“DCI”) format that can schedule one or more physical uplink shared channels (“PUSCHs”), one or more physical downlink shared channels (“PDSCHs”), and/or one or more PDSCHs and physical uplink shared channels (“PUSCHs”) with reuse of as many DCI fields as possible may alleviate a potential PDCCH blocking issue for high SCS.

FIG. 4 is a graph diagram 400 illustrating one embodiment of a maximum number of monitored PDCCH candidates per slot and per serving cell (e.g., maximum number of non-overlapped CCEs per slot).

In some embodiments, a PDCCH monitoring mechanism may be used for a new unified DCI format that can schedule both uplink and downlink across one or more slots.

In various embodiments, there may be prioritized mapping of a new unified DCI format to CCEs based on an enhanced search space sets configuration if the subcarrier spacing is above a certain configured and/or indicated threshold (or any other high priority downlink control information (“DCI”) format, for example DCI format 0_2 and format 1_2 for ultra-reliable low latency communication (“URLLC”)).

In certain embodiments, if one set of DCI formats are configured for monitoring, then selective or reduced monitoring may be applied for a second set of DC formats.

Some embodiments described herein may have a benefit of enabling reduced PDCCH monitoring for a UE as that UE may not be required to receive separate DCI's for scheduling DL and UL across one or more slots. Various embodiments described herein may have a benefit of alleviating a potential PDCCH blocking issue for high SCS.

In a first embodiment, there may be reduced monitoring of DCI formats if a new unified DCI format is monitored. In certain configurations of the first embodiment, if a UE is configured to monitor the new unified DCI format that schedules both DL and UL transmissions across one or more slots, then the UE is not required to monitor at least one of the DCI formats among DCI formats 0_0, 0_1, 0_2, 1_0, 1_1 and 1_2. Such a monitoring configuration may be fixed or semi-statically configured to the UE via higher layers such as radio resource control (“RRC”) signaling or dependent upon the configured numerology.

In some configurations of the first embodiment, if the UE is configured to monitor the new unified DCI format, then the UE is not required to monitor DCI format 0_1 and 1_1. In such configurations, DL and/or UL scheduling may be done with any of the DCI formats among 0_0, 0_2, 1_0, 1_2. In various configurations of the first embodiment, if the UE is configured to monitor the new unified DCI format, then the UE is not required to monitor DCI format 1_1 and 1_2. In such configurations, DL may only be scheduled with the new unified DCI format and fallback DCI format 1_0 and UL may be scheduled with the new unified DCI format and/or DCI formats 0_0, 0_1, and 0_2. In certain configurations of the first embodiment, if the UE is configured to monitor the new unified DCI format, then the UE is not required to monitor DCI format 0_1 and 0_2. In such configurations, UL may only be scheduled with the new unified DCI format and fallback DCI format 0_0 and DL may be scheduled with the new unified DCI format and/or DCI formats 1_0, 1_1, and 1_2. In some configurations of the first embodiment, the UE starts to monitor a particular DCI format (or a particular search space set) of a particular search space configuration upon receiving an indication of activation of monitoring of the particular DCI format (or the particular search space set). In such configurations, the UE stops monitoring the particular DCI format and/or search space set upon receiving an indication of deactivation of monitoring the particular DCI format and/or search space set. In one example, the indication of activation and/or deactivation of monitoring the particular DCI format and/or search space set is received via a medium access control (“MAC”) control element (“CE”).

In various configurations of the first embodiment, the UE receives a first search space configuration associated with at least a first DCI format (e.g., the new unified DCI format) and a second search space configuration associated with at least a second DCI format (e.g., DCI format 1_1). The UE monitors PDCCH according to the second search space configuration. Upon receiving a MAC CE indicating an activation of monitoring PDCCH according to the first search space configuration (or monitoring the first DCI format based on the first search space configuration), the UE stops monitoring the second DCI format based on the second search space configuration. Upon receiving a MAC CE indicating a deactivation of monitoring PDCCH according to the first search space configuration (or monitoring the first DCI format based on the first search space configuration), the UE restarts monitoring the second DCI format based on the second search space configuration. In one example, the first search space configuration is the same as the second search space configuration. In another example, the first search space configuration has a lower search space index than the second search space configuration, and the lower search space index corresponds to a higher search space priority.

In a second embodiment, a search space configuration and/or CCE mapping may be used if a new unified DCI format is monitored. In certain configurations of the second embodiment, if the UE is configured to monitor the new unified DCI format to schedule both DL and UL transmissions across one or more slots, then a search space configuration-based priority is given to this new DCI format. This may mean that the mapping of the new DCI format to the CCEs is prioritized over other DCI formats. In some configurations of the second embodiment, a new separate or a dedicated search space is used for high priority DCI formats depending upon various scenarios, requirements, and/or configurations. For example, if high subcarrier spacing is used, then the new unified DCI format is given high priority and mapped to CCEs based on a configuration of the new separate and/or dedicated search space set that may be configured before the user-specific search space. In various configurations of the second embodiment, the same search space (e.g., user equipment specific search space (“USS”), common search space (“CSS”)) is used for the new unified DCI format, but a lower index identifier (“ID”) of the search space is prioritized with this new unified DCI format to reduce any blocking probability for high priority DCI formats.

In a third embodiment, monitoring occasions of the new unified DCI format may be skipped. In certain configurations of the third embodiment, if a UE is configured to monitor the new unified DCI format to schedule both DL and UL transmissions across one or more slots and if upon monitoring the UE is able to decode the new unified DCI format, then the UE is not required to monitor the new unified DCI format for at least a partial or a complete duration of a scheduled PDSCH and/or PUSCH on the monitoring occasions within that monitoring periodicity.

In some configurations of the third embodiment, if a UE is configured to monitor the new unified DCI format to schedule both DL-UL, DL-UL-DL-UL, or UL-DL-UL-DL directions, then the UE may skip monitoring of other DCI formats in USS for a duration specified in the new unified DCI format. In various configurations of the third embodiment, the UE may skip monitoring a DCI format in a control resource set (“CORESET”) ID and/or search space ID for a duration specified in the new unified DCI format.

In certain configurations of the third embodiment, instead of the new unified DCI containing fields for both DL and UL, the new unified DCI contains only linking information of other DCI DL communication or vice-versa (e.g., linking information of other DCI UL communication). In such configurations, a DCI field contains information related to UL DCI transmission such as UL DCI format and/or size, aggregation level, CORESET ID, search space ID, and slot number and/or offset (e.g., offset from DL DCI) so that the UE does not perform blind decoding to decode UL DCI, and the UE may skip DCI monitoring in a remaining slot until a slot in which it receives the UL DCI.

In a fourth embodiment, there may be a new unified DCI format size alignment.

In some configurations of the fourth embodiment, a new unified DCI format may be used to schedule both DL and UL transmissions across one or more slots, and a size of the DCI (e.g., number of bits) may be the same as or greater than a size of at least one DCI format (e.g., one of DCI formats 0_0, 0_1, 0_2, 1_0, 1_1, and 1_2).

In various configurations of the fourth embodiment, truncation may be applied to the new unified DCI format to enable a size alignment with at least one DCI format among DCI formats 0_0, 0_1, 0_2, 1_0, 1_1, and 1_2 such that at least a current limitation if followed to enable monitoring of no more than 4 different DCI sizes for a cell and a limitation to enable monitoring of no more than 3 different DCI sizes with cell radio network temporary identifier (“C-RNTI”) for the cell. In certain configurations of the fourth embodiment, padding may be applied to at least one DCI formats among DCI formats 0_0, 0_1, 0_2, 1_0, 1_1, and 1_2 to enable a size alignment with the new unified DCI format such that at least a current limitation if followed to enable monitoring of no more than 4 different DCI sizes for a cell and a limitation to enable monitoring of no more than 3 different DCI sizes with C-RNTI for the cell.

In a fifth embodiment, there may be a configuration of a new unified DCI format. In one configuration of the fifth embodiment, a UE is explicitly configured and/or indicated to monitor the new unified DCI format to schedule both DL and UL transmissions across one or more slots. In such embodiments, an explicit configuration and/or indication to monitor the new unified DCI format may be done semi-statically via higher layer signaling such as RRC signaling that may either enable or disable monitoring of the new unified DCI format. In another configuration of the fifth embodiment, if an RRC signaling parameter is not configured at a UE, then the UE may not be required to monitor the new unified DCI format for any search space sets.

In some configurations of the fifth embodiment, a UE may receive an implicit indication and/or configuration to monitor the new unified DCI format. One example of an implicit indication and/or configuration may be based on a numerology (e.g., subcarrier spacing). If the subcarrier spacing configured and/or indicated is above a certain threshold, then the UE may assume to be configured to monitor the new unified DCI format. The threshold for subcarrier spacing may either be fixed or configured and/or indicated in a semi-static and/or a dynamic manner. In various configurations of the fifth embodiment, a UE is not expected to be configured with a search space including the new unified DCI format in a DL bandwidth part (“BWP”) configured with a SCS smaller than a threshold value (e.g., 120 kHz).

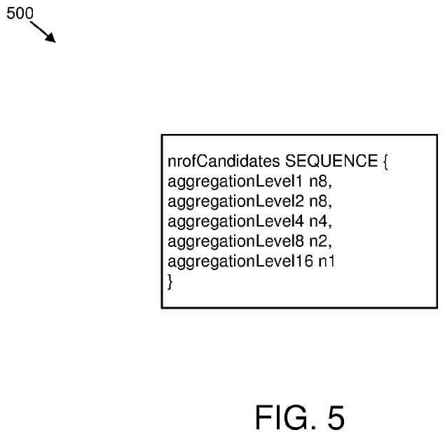

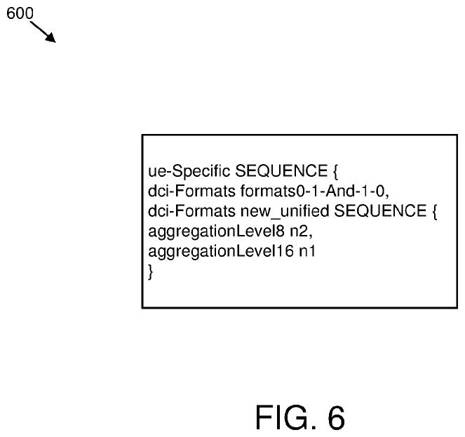

In a sixth embodiment, there may be a search space configuration for a new unified DCI format. In certain configurations of the sixth embodiment, if a UE is configured to monitor the new unified DCI format to schedule both DL and UL transmissions across one or more slots and upon monitoring for a given search space configuration, then only a sub-set of aggregation levels may be applicable for this new DCI format. An example implementation of the search space configuration is shown in FIG. 5 and FIG. 6 for configuring only a sub-set of aggregation levels for this new unified DCI format in comparison to other DCI formats.

FIG. 5 is a program code diagram 500 illustrating one embodiment of NR candidate sequences. FIG. 6 is a program code diagram 600 illustrating one embodiment of UE specific sequences.

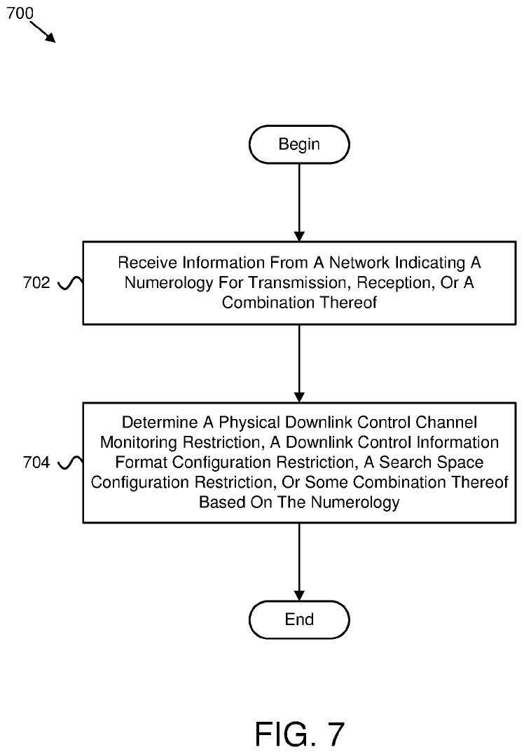

FIG. 7 is a flow chart diagram illustrating one embodiment of a method 700 for restrictions based on a configured numerology. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702 information from a network indicating a numerology for transmission, reception, or a combination thereof. In some embodiments, the method 700 includes determining 704 a physical downlink control channel monitoring restriction, a downlink control information format configuration restriction, a search space configuration restriction, or some combination thereof based on the numerology.

In certain embodiments, the physical downlink control channel monitoring restriction configures a physical downlink control channel monitoring limitation across multiple slots in response to the numerology being above a predetermined threshold. In some embodiments, a number of slots of the multiple slots for the physical downlink control channel monitoring restriction is associated with the numerology. In various embodiments, a number of slots of the multiple slots for the physical downlink control channel monitoring restriction is associated with a number of slots scheduled for transmission by downlink control information.

In one embodiment, a user equipment capability for physical downlink control channel monitoring is defined across multiple slots. In certain embodiments, the downlink control information format configuration restriction applies to monitor only a downlink control information format that schedules multiple slots. In some embodiments, the downlink control information format schedules both uplink and downlink transmissions.

In various embodiments, the downlink control information format configuration comprises at least one high priority downlink control information format that is a unified user equipment-specific downlink control information format that schedules uplink and downlink transmissions across each transmission time interval. In one embodiment, the method 700 further comprises configuring an activation command for at least one high priority downlink control information format, and, upon receiving the activation command, monitoring only the at least one high priority downlink control information format. In certain embodiments, the method 700 further comprises configuring a deactivation command for at least one high priority downlink control information format, and, upon receiving the deactivation command, stopping monitoring or stopping adhering to any priority levels for the at least one high priority downlink control information format.

In some embodiments, the method 700 further comprises configuring a threshold value for subcarrier spacing, and, in response to determining to use a subcarrier spacing value greater than or equal to the threshold value, monitoring only a high priority unified user equipment-specific downlink control information format. In various embodiments, the search space configuration restriction is dedicated for only high priority downlink control information formats and is a user equipment-specific search space different from a prior user equipment-specific search space and a common search space. In one embodiment, the search space configuration restriction is dedicated for only high priority downlink control information formats and is a user equipment-specific search space with a lowest set of indices.

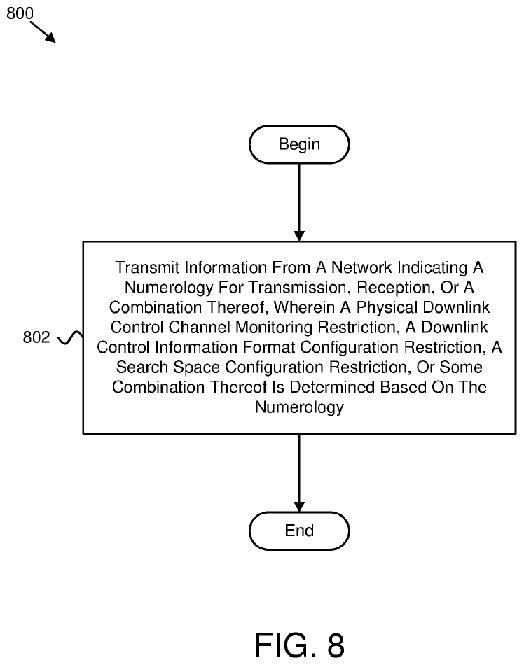

FIG. 8 is a flow chart diagram illustrating one embodiment of a method 800 for restrictions based on a configured numerology. In some embodiments, the method 800 is performed by an apparatus, such as the network unit 104. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes transmitting 802 information from a network indicating a numerology for transmission, reception, or a combination thereof. A physical downlink control channel monitoring restriction, a downlink control information format configuration restriction, a search space configuration restriction, or some combination thereof is determined based on the numerology.

In certain embodiments, the physical downlink control channel monitoring restriction configures a physical downlink control channel monitoring limitation across multiple slots in response to the numerology being above a predetermined threshold. In some embodiments, a number of slots of the multiple slots for the physical downlink control channel monitoring restriction is associated with the numerology. In various embodiments, a number of slots of the multiple slots for the physical downlink control channel monitoring restriction is associated with a number of slots scheduled for transmission by downlink control information.

In one embodiment, a user equipment capability for physical downlink control channel monitoring is defined across multiple slots. In certain embodiments, the downlink control information format configuration restriction applies to monitor only a downlink control information format that schedules multiple slots. In some embodiments, the downlink control information format schedules both uplink and downlink transmissions.

In various embodiments, the downlink control information format configuration comprises at least one high priority downlink control information format that is a unified user equipment-specific downlink control information format that schedules uplink and downlink transmissions across each transmission time interval. In one embodiment, the search space configuration restriction is dedicated for only high priority downlink control information formats and is a user equipment-specific search space different from a prior user equipment-specific search space and a common search space. In certain embodiments, the search space configuration restriction is dedicated for only high priority downlink control information formats and is a user equipment-specific search space with a lowest set of indices.

In one embodiment, a method comprises: receiving information from a network indicating a numerology for transmission, reception, or a combination thereof; and determining a physical downlink control channel monitoring restriction, a downlink control information format configuration restriction, a search space configuration restriction, or some combination thereof based on the numerology.

In certain embodiments, the physical downlink control channel monitoring restriction configures a physical downlink control channel monitoring limitation across multiple slots in response to the numerology being above a predetermined threshold.

In some embodiments, a number of slots of the multiple slots for the physical downlink control channel monitoring restriction is associated with the numerology.

In various embodiments, a number of slots of the multiple slots for the physical downlink control channel monitoring restriction is associated with a number of slots scheduled for transmission by downlink control information.

In one embodiment, a user equipment capability for physical downlink control channel monitoring is defined across multiple slots.

In certain embodiments, the downlink control information format configuration restriction applies to monitor only a downlink control information format that schedules multiple slots.

In some embodiments, the downlink control information format schedules both uplink and downlink transmissions.

In various embodiments, the downlink control information format configuration comprises at least one high priority downlink control information format that is a unified user equipment-specific downlink control information format that schedules uplink and downlink transmissions across each transmission time interval.

In one embodiment, the method further comprises configuring an activation command for at least one high priority downlink control information format, and, upon receiving the activation command, monitoring only the at least one high priority downlink control information format.

In certain embodiments, the method further comprises configuring a deactivation command for at least one high priority downlink control information format, and, upon receiving the deactivation command, stopping monitoring or stopping adhering to any priority levels for the at least one high priority downlink control information format.

In some embodiments, the method further comprises configuring a threshold value for subcarrier spacing, and, in response to determining to use a subcarrier spacing value greater than or equal to the threshold value, monitoring only a high priority unified user equipment-specific downlink control information format.

In various embodiments, the search space configuration restriction is dedicated for only high priority downlink control information formats and is a user equipment-specific search space different from a prior user equipment-specific search space and a common search space.

In one embodiment, the search space configuration restriction is dedicated for only high priority downlink control information formats and is a user equipment-specific search space with a lowest set of indices.

In one embodiment, an apparatus comprises: a receiver that receives information from a network indicating a numerology for transmission, reception, or a combination thereof: and a processor that determines a physical downlink control channel monitoring restriction, a downlink control information format configuration restriction, a search space configuration restriction, or some combination thereof based on the numerology.

In certain embodiments, the physical downlink control channel monitoring restriction configures a physical downlink control channel monitoring limitation across multiple slots in response to the numerology being above a predetermined threshold.

In some embodiments, a number of slots of the multiple slots for the physical downlink control channel monitoring restriction is associated with the numerology.

In various embodiments, a number of slots of the multiple slots for the physical downlink control channel monitoring restriction is associated with a number of slots scheduled for transmission by downlink control information.

In one embodiment, a user equipment capability for physical downlink control channel monitoring is defined across multiple slots.

In certain embodiments, the downlink control information format configuration restriction applies to monitor only a downlink control information format that schedules multiple slots.

In some embodiments, the downlink control information format schedules both uplink and downlink transmissions.

In various embodiments, the downlink control information format configuration comprises at least one high priority downlink control information format that is a unified user equipment-specific downlink control information format that schedules uplink and downlink transmissions across each transmission time interval.

In one embodiment, the processor configures an activation command for at least one high priority downlink control information format, and, upon receiving the activation command, monitors only the at least one high priority downlink control information format.

In certain embodiments, the processor configures a deactivation command for at least one high priority downlink control information format, and, upon receiving the deactivation command, stops monitoring or stopping adhering to any priority levels for the at least one high priority downlink control information format.

In some embodiments, the processor configures a threshold value for subcarrier spacing, and, in response to determining to use a subcarrier spacing value greater than or equal to the threshold value, monitors only a high priority unified user equipment-specific downlink control information format.

In various embodiments, the search space configuration restriction is dedicated for only high priority downlink control information formats and is a user equipment-specific search space different from a prior user equipment-specific search space and a common search space.

In one embodiment, the search space configuration restriction is dedicated for only high priority downlink control information formats and is a user equipment-specific search space with a lowest set of indices.

In one embodiment, a method comprises: transmitting information from a network indicating a numerology for transmission, reception, or a combination thereof, wherein a physical downlink control channel monitoring restriction, a downlink control information format configuration restriction, a search space configuration restriction, or some combination thereof is determined based on the numerology.

In certain embodiments, the physical downlink control channel monitoring restriction configures a physical downlink control channel monitoring limitation across multiple slots in response to the numerology being above a predetermined threshold.

In some embodiments, a number of slots of the multiple slots for the physical downlink control channel monitoring restriction is associated with the numerology.

In various embodiments, a number of slots of the multiple slots for the physical downlink control channel monitoring restriction is associated with a number of slots scheduled for transmission by downlink control information.

In one embodiment, a user equipment capability for physical downlink control channel monitoring is defined across multiple slots.

In certain embodiments, the downlink control information format configuration restriction applies to monitor only a downlink control information format that schedules multiple slots.

In some embodiments, the downlink control information format schedules both uplink and downlink transmissions.

In various embodiments, the downlink control information format configuration comprises at least one high priority downlink control information format that is a unified user equipment-specific downlink control information format that schedules uplink and downlink transmissions across each transmission time interval.

In one embodiment, the search space configuration restriction is dedicated for only high priority downlink control information formats and is a user equipment-specific search space different from a prior user equipment-specific search space and a common search space.

In certain embodiments, the search space configuration restriction is dedicated for only high priority downlink control information formats and is a user equipment-specific search space with a lowest set of indices.

In one embodiment, an apparatus comprises: a transmitter that transmits information from a network indicating a numerology for transmission, reception, or a combination thereof, wherein a physical downlink control channel monitoring restriction, a downlink control information format configuration restriction, a search space configuration restriction, or some combination thereof is determined based on the numerology.

In certain embodiments, the physical downlink control channel monitoring restriction configures a physical downlink control channel monitoring limitation across multiple slots in response to the numerology being above a predetermined threshold.

In some embodiments, a number of slots of the multiple slots for the physical downlink control channel monitoring restriction is associated with the numerology.

In various embodiments, a number of slots of the multiple slots for the physical downlink control channel monitoring restriction is associated with a number of slots scheduled for transmission by downlink control information.

In one embodiment, a user equipment capability for physical downlink control channel monitoring is defined across multiple slots.

In certain embodiments, the downlink control information format configuration restriction applies to monitor only a downlink control information format that schedules multiple slots.

In some embodiments, the downlink control information format schedules both uplink and downlink transmissions.

In various embodiments, the downlink control information format configuration comprises at least one high priority downlink control information format that is a unified user equipment-specific downlink control information format that schedules uplink and downlink transmissions across each transmission time interval.

In one embodiment, the search space configuration restriction is dedicated for only high priority downlink control information formats and is a user equipment-specific search space different from a prior user equipment-specific search space and a common search space.

In certain embodiments, the search space configuration restriction is dedicated for only high priority downlink control information formats and is a user equipment-specific search space with a lowest set of indices.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
receiving information from a network indicating a numerology for transmission, reception, or a combination thereof; and
determining a physical downlink control channel monitoring restriction, a downlink control information format configuration restriction, a search space configuration restriction, or some combination thereof based on the numerology.

2. The method of claim 1, wherein the physical downlink control channel monitoring restriction configures a physical downlink control channel monitoring limitation across multiple slots in response to the numerology being above a predetermined threshold.

3. The method of claim 2, wherein a number of slots of the multiple slots for the physical downlink control channel monitoring restriction is associated with the numerology, associated with the number of slots scheduled for transmission by downlink control information, or a combination thereof.

4. The method of claim 1, wherein a user equipment capability for physical downlink control channel monitoring is defined across multiple slots.

5. The method of claim 1, wherein the downlink control information format configuration restriction applies to monitor only a high priority downlink control information format, monitor only a downlink control information format that schedules multiple slots, monitor only a downlink control information format that schedules both uplink and downlink transmission, or some combination thereof.

6. The method of claim 1, further comprising configuring a threshold value for subcarrier spacing, and, in response to determining to use a subcarrier spacing value greater than or equal to the threshold value, monitoring only a high priority unified user equipment-specific downlink control information format.

7. The method of claim 1, wherein the search space configuration restriction is dedicated for only high priority downlink control information formats and is a user equipment-specific search space different from a prior user equipment-specific search space and a common search space.

8. The method of claim 1, wherein the search space configuration restriction is dedicated for only high priority downlink control information formats and is a user equipment-specific search space with a lowest set of indices.

9. An apparatus comprising:
a receiver that receives information from a network indicating a numerology for transmission, reception, or a combination thereof, and
a processor that determines a physical downlink control channel monitoring restriction, a downlink control information format configuration restriction, a search space configuration restriction, or some combination thereof based on the numerology.

10. The apparatus of claim 9, wherein the physical downlink control channel monitoring restriction configures a physical downlink control channel monitoring limitation across multiple slots in response to the numerology being above a predetermined threshold.

11. The apparatus of claim 10, wherein a number of slots of the multiple slots for the physical downlink control channel monitoring restriction is associated with the numerology, associated with the number of slots scheduled for transmission by downlink control information, or a combination thereof.

12. The apparatus of claim 9, wherein a user equipment capability for physical downlink control channel monitoring is defined across multiple slots.

13. The apparatus of claim 9, wherein the downlink control information format configuration restriction applies to monitor only a high priority downlink control information format, monitor only a downlink control information format that schedules multiple slots, monitor only a downlink control information format that schedules both uplink and downlink transmission, or some combination thereof.

14. The apparatus of claim 9, wherein the processor configures a threshold value for subcarrier spacing, and, in response to determining to use a subcarrier spacing value greater than or equal to the threshold value, monitors only a high priority unified user equipment-specific downlink control information format.

15. The apparatus of claim 9, wherein the search space configuration restriction is dedicated for only high priority downlink control information formats and is a user equipment-specific search space different from a prior user equipment-specific search space and a common search space.

16. The apparatus of claim 9, wherein the search space configuration restriction is dedicated for only high priority downlink control information formats and is a user equipment-specific search space with a lowest set of indices.

17. (canceled)

18. The apparatus of claim 20, wherein the network configures a physical downlink control channel monitoring limitation across multiple slots in response to the numerology being above a predetermined threshold.

19. The apparatus of claim 18, wherein a number of slots of the multiple slots for the physical downlink control channel monitoring restriction is associated with the numerology, associated with a number of slots scheduled for transmission by downlink control information, or some combination thereof.

20. An apparatus comprising:
a transmitter that transmits information from a network indicating a numerology for transmission, reception, or a combination thereof, wherein a physical downlink control channel monitoring restriction, a downlink control information format configuration restriction, a search space configuration restriction, or some combination thereof is determined based on the numerology.

21. The apparatus of claim 20, wherein the downlink control information format configuration restriction applies to monitor only a high priority downlink control information format, monitor only a downlink control information format that schedules multiple slots, monitor only a downlink control information format that schedules both uplink and downlink transmission, or some combination thereof.
